(19) United States
(12) Patent Application Publication
(10) Pub. No.: US 2009/0327808 A1
(43) Pub. Date: Dec. 31, 2009

(54) IMAGE FORMING APPARATUS

(75) Inventor: Kazuhiko TAKIZAWA, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/472,711

(22) Filed: May 27, 2009

(30) Foreign Application Priority Data
Jun. 27, 2008 (JP) 2008-168305

(51) Int. Cl. G06F 11/07

(52) U.S. Cl. 714/24; 714/57; 714/E11.023; 714/E11.025

(57) ABSTRACT

An image forming apparatus includes an error detection unit, a determination unit, an output unit, and a power source control unit. The error detection unit detects an occurrence of an error in printing operation. The determination unit determines whether or not to perform power-off operation based on a detection result of the error occurrence detected by the error detection unit. The output unit outputs an error content of the error where the determination unit determines to perform the power-off operation. The power source control unit performs the power-off operation where the determination unit determines to perform the power-off operation

### BACKGROUND OF THE INVENTION

1. Field of the Invention

The present invention relates to an image forming apparatus having a power saving function.

2. Description of Related Art

A related art image forming apparatus has been known which enters into a power saving mode in a case where printing operation becomes non-executable caused by an error in a print engine unit therein. Such a related art image forming apparatus is disclosed in Japanese Un-examined Patent Application Publication No. 2004-12848, for example.

In a case where the error is eliminated from the engine unit and the printing operation becomes executable, the image forming apparatus disclosed in the above document is automatically recovered from the power saving mode and resumes the printing operation. Such a related art image forming apparatus disclosed in the above document can arrange thereof to enter into the power saving mode upon elapse of a certain time period from a time at which the printing operation becomes non-executable, or can change a waiting time period until which the image forming apparatus is entered into the power saving mode according to a type of the error occurred.

The related art image forming apparatus disclosed in the above document eliminates the error occurred in the engine unit. However, the related art image forming apparatus repeatedly performs a confirmation process whether or not that recovery from the power saving mode can be made, causing failure of power saving in a control unit controlling the image forming apparatus as a whole.

The present invention provides an image forming apparatus capable of saving power in a case where printing operation becomes non-executable caused by an error in a print engine unit thereof.

### BRIEF SUMMARY OF THE INVENTION

According to one aspect of the invention, an image forming apparatus includes: an error detection unit detecting an occurrence of an error in printing operation; a determination unit determining whether or not to perform power-off operation based on a detection result of the error occurrence detected by the error detection unit; an output unit outputting an error content of the error where the determination unit determines to perform the power-off operation; and a power source control unit performing the power-off operation where the determination unit determines to perform the power-off operation

According to another aspect of the invention, an image forming apparatus includes: an error detection unit detecting an occurrence of an error in printing operation; a determination unit determining whether or not to perform power-off operation based on a detection result of the error occurrence detected by the error detection unit; an output unit outputting power-off information where the determination unit determines to perform the power-off operation; and a power source control unit performing the power-off operation where the determination unit determines to perform the power-off operation.

Additional features and advantages of the present invention will be more fully apparent from the following detailed description of embodiments, the accompanying drawings and the associated claims.

### BRIEF DESCRIPTION OF THE DRAWINGS

A more complete appreciation of the aspects of the invention and many of the attendant advantage thereof will be readily obtained as the same becomes better understood by reference to the following detailed description when considered in connection with the accompanying drawings, wherein:

FIG. 1 is a schematic block diagram illustrating a printer serving as an image forming apparatus according to a first embodiment of the present invention;

FIG. 2 is a schematic diagram illustrating an example of error information and an error recovery method displayed in a display unit;

FIG. 3 is a flowchart illustrating an example procedure for performing power-off operation of the printer;

FIG. 4 is a flowchart illustrating an example procedure for activating the printer being powered off;

FIG. 5 is a schematic block diagram illustrating a printer serving as an image forming apparatus according to a second embodiment of the present invention;

FIG. 6 is a schematic diagram illustrating an example of e-mail notifying of power-off operation according to the second embodiment of the present invention; and

FIG. 7 is a flowchart illustrating an example procedure for performing power-off operation of the printer according to the second embodiment of the present invention.

### DETAILED DESCRIPTION OF PREFERRED EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, like reference numerals designate identical or corresponding parts throughout the several views.

### First Embodiment

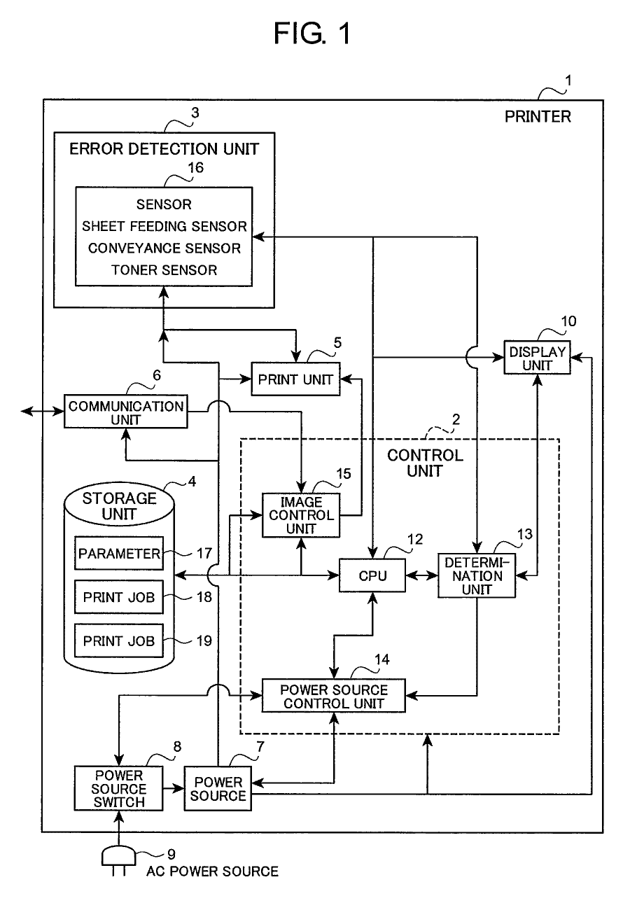

Referring to FIG. 1, a printer 1 serving as an image forming apparatus according to a first embodiment of the present invention is illustrated in a block diagram. The printer 1 serving as the image forming apparatus is capable of printing an image on a sheet serving as a recording medium based on print data input from an external device (not shown). The printer 1 includes: a control unit 2 controlling firmware installed inside the printer 1; an error detection unit 3 detecting an error occurrence; a storage unit 4 storing various information therein; a print unit 5 printing the image with respect to the sheet; a communication unit 6 communicating with an external device (not shown); a power source 7 supplying power to each component; a power source switch 8 switching supply of the power from an AC power source 9 ON and OFF; and a display unit 10 serving as an output unit displaying a state of the printer 1.

The control unit 2 includes: a central processing unit (CPU) 12 serving as a center for controlling the firmware; a determination unit 13 determining whether or not to perform power-off operation based on error information notified by the error detection unit 3; a power source control unit 14 performing the power-off operation by controlling the power source switch 8; and an image control unit 15 processing by editing or mapping the print data received from the external device (not shown) through the communication unit 6 and transmitting the processed print data to the print unit 5.

The error detection unit 3 includes various sensors 16. The error detection unit 3 detects errors such as out-of-toner, out-of-sheet, and paper jam occurred in the printer 1 based on information detected by the various sensors 16, and notifies the determination unit 13 of the error information. For example, the various sensors 16 include: a sheet feeding sensor detecting a feeding state of the sheet stored in a sheet tray (not shown); a conveyance sensor detecting a conveyance state of the sheet on a sheet conveyance path; and a toner sensor detecting a state of the toner stored in a toner cartridge (not shown) included in the print unit 5.

The storage unit 4 serves as a nonvolatile storage memory, and stores a parameter 17 serving as a setting value to be stored in the printer 1 or the print data received through the communication unit 6 as print jobs 18 or 19 therein until the printing operation is actually performed. The storage unit 4, for example, can be a magnetic medium such as a read only memory (ROM), a flash memory, and a hard disk drive (HDD).

The print unit 5 is a print engine employing, for example, an electrophotographic method, and prints the image on the sheet based on the print data processed by the image control unit 15.

The communication unit 6, for example, communicates with the external device through a network or a universal serial bus (UBS) and the like, and serves as an interface transmitting the print data received to the image control unit 15.

The display unit 10 serves as a storage display device such as electronic paper using cholesteric liquid crystal capable of allowing information displayed thereon to be rewritten by voltage supply and allowing the information displayed thereon to continue to be displayed in a state that the voltage supply is stopped. Therefore, the display unit 10 serving as the storage display device displays the information thereon in a case where the power supply is stopped. The display unit 10 can be a display device employing, for example, an electrophoretic method or an electric liquid powder method. In a normal state, the display unit 10 serves as an operation panel displaying a state of the printer 1. Herein, the state of the printer 1 includes online or offline information indicating whether or not that the printer 1 can perform the printing operation, for example, information regarding inside of the printer 1, such as a state of print job in the printing operation and a remaining quantity of a consumable element such as the toner. The display unit 10 displays the error information and the error recovery method (described later) upon reception of a notification of the power-off operation from the determination unit 13. Upon completion of displaying such information and method, the display unit 10 notifies the power source control unit 14 of the display completion through the determination unit 13. Since the display unit 10 is the storage display unit, the error information and the error recovery method remain displayed on the display unit 10 even in a case where the power supply is stopped. Herein, the error information and the error recovery method displayed on the display unit 10 may not be easily seen compared with the state of the printer 1 displayed on the display unit 10 in the normal state. Therefore, for example, a size of a letter in the error information and the error recovery method displayed on the display unit 10 can be enlarged so as to be easily seen by a user.

The determination unit 13 analyzes the error information notified by the error detection unit 3, and determines whether or not to perform the power-off operation. Where the determination unit 13 determines to perform the power-off operation in a case where the notified error is not only non-recoverable by the printer 1 but also continuation of the print operation is not possible, the determination unit 13 notifies the display unit 10 and the power source control unit 14 accordingly. In a case where the error not recoverable by the printer 1 occurs, for example, a case where the sheet is jammed in the sheet conveyance path, a user needs to remove the sheet from the sheet conveyance path to recover the printer 1 from the error. Consequently, the electric power is wasted from a time at which the user removes the sheet from the conveyance path to a time at which the printer 1 returns to a normal state. In such a state, the determination unit 13 determines to perform the power-off operation.

The power source control unit 14 allows the power source 7 to be turned off and the power source switch 8 to be in an off state upon reception of the power-off notification from the determination unit 13 and the display completion notification from the display unit 10 through the determination unit 13. Herein, the off state of the power source switch 8 represents a state substantially similar to a case where the user turns off the power source switch 8. When the user turns on the power source switch 8 being in the off state, the power is applied to the printer 1.

The image control unit 15 processes the print data received through the communication unit 6 by editing or mapping as necessary and transmits the processed print data to the print unit 5. The image control unit 15 allows the print data not yet printed at a time of the error occurrence to be stored in the storage unit 4 as the print job. When the printer 1 is recovered from the error, or when the printer 1 is activated, the image control unit 15 reads the print job stored in the storage unit 4, processes the print data by editing or mapping as necessary, and transmits the processed print data to the print unit 5.

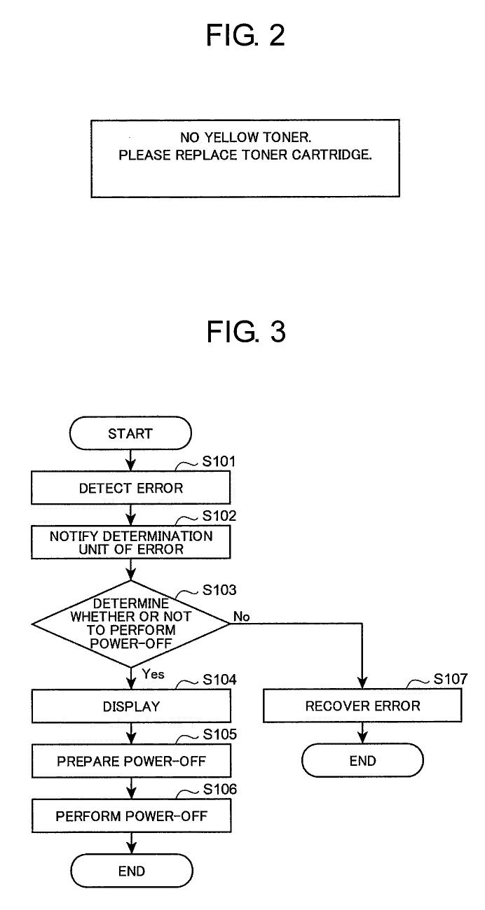

Referring to FIG. 2, an example of the error information and the error recovery method displayed on the display screen 10 is illustrated. As illustrated in FIG. 2, the error information is “NO YELLOW TONER” and the error recovery method is “PLEASE REPLACE TONER CARTRIDGE.” In a case where a display size or resolution of the display unit 10 is not suitable, the error information and the recovery method can be simplified as a display message, for example, “NO TONER (Y)” and “REPLACE TONER CARTRIDGE,” respectively. Such a simplified display message may be prepared beforehand so as to be displayed after the power-off operation is performed.

Referring to TABLE 1, an example of an administration table including the error information, the error recovery method, and the presence or absence of the power-off operation is illustrated. In TABLE 1, “NO.” represents an administrative number of the error information to be administrated by the control unit 2. Each of “ERROR INFORMATION” and “RECOVERY METHOD” in TABLE 1 includes the display message to be displayed on the display unit 10 in a case of the error occurrence. Moreover, “POWER OFF” in TABLE 1 represents whether or not to perform the power-off operation determined beforehand by the determination unit 13 in response to the error occurred. As illustrated in FIG. 2, in a case where the error of NO. 1 occurs, for example, the display unit 10 displays “NO YELLOW TONER” and “PLEASE REPLACE TONER CARTRIDGE” as the error information and the error recovery method, respectively, and the determination unit 13 determines to perform the power-off operation. It is to be noted that the message ““NO YELLOW TONER” or “NO TONER (Y)” indicates situations that there is little amount of the toner to be used.

TABLE 1

| NO. | ERROR INFO. | RECOVERY METHOD | POWER-OFF |
|---|---|---|---|
| 1 | NO YELLOW TONER | PLEASE REPLACE | TO PERFORM |
| | | TONER CARTRIDGE | |
| 2 | NO SHEET IN TRAY 1 | PLEASE PLACE SHEET | TO PERFORM |
| | | IN TRAY 1 | |
| 3 | NO SHEET IN TRAY 2 | PLEASE PLACE SHEET | NOT TO PERFORM |
| | | IN TRAY 2 | |
| 4 | PAPER JAMMED | PLEASE OPEN TOP COVER, | TO PERFORM |
| | | DETACH TONER CARTRIGE, | |
| | | AND REMOVE JAMMED SHEET | |

Referring to a flowchart of FIG. 3, an example procedure for performing the power-off operation of the printer 1 is described.

The error detection unit 3 identifies the error occurred in the printer 1 based on the information detected by the various sensors 16 (step S101). For example, in a case where the toner sensor cannot detect the toner in the toner cartridge (not shown), the error detection unit 3 identifies the error as a “no toner error.”

The error detection unit 3 notifies the determination unit 13 of the identified error as the error information. The error detection unit 3 notifies the determination unit 13 of the “NO.” displayed in TABLE 1. Herein, for example, where the “NO.” notified to the determination unit 13 is “1,” the determination unit 13 recognizes the error occurred in the printer 1 is “no yellow toner.”

Subsequently, the determination unit 13 determines whether or not to perform the power-off operation based on the error information notified by the error detection unit 3. Where the determination unit 13 determines to perform the power-off operation in a case where the notified error is not only non-recoverable by the printer 1 but also continuation of the print operation is not possible, the determination unit 13 notifies the display unit 10 and the power source control unit 14 accordingly (Yes at step S103). As illustrated in TABLE 1, a criterion for the power-off operation determined by the determination unit 13 is arranged beforehand. However, each of the determination criteria may be modified by the user through the operation panel.

Upon reception of the notification of performing the power-off operation (also referred to as the power-off notification) from the determination unit 13, the display unit 10 displays the error information and the error recovery method thereon (step S104). Upon completion of displaying the error information and the error recovery method, the display unit 10 notifies the power source control unit 14 of the display completion through the determination unit 13.

The power source control unit 14 can perform the power-off operation at a time at which the power-off notification from the determination unit 13 and the display completion notification form the display unit 10 are received. In a case where the print data not yet printed exists at a time of the error occurrence, the image control unit 15 allows such print data to be stored in the storage unit 4 as the print job. Moreover, in a case where the print data is being received through the communication unit 6 at a time of the error occurrence, the image control unit 15 allows such print data to be stored in the storage unit 4 as the print job (step S105).

When preparation for the power-off operation is completed (step S105), the power source control unit 14 allows the power source 7 to be turned off and the power source switch 8 to be in the off state, thereby performing the power-off operation (step S106). Herein, the power-off procedure ends. Hereafter, assuming that the printer 1 is not activated until the user turns on the power source switch 8 in a case where the power-off operation is performed by the power source control unit 14.

On the other hand, where the determination unit 13 determines not to perform the power-off operation (No at step S103), the error recoverable by the printer 1 is recovered, and the power-off procedure ends.

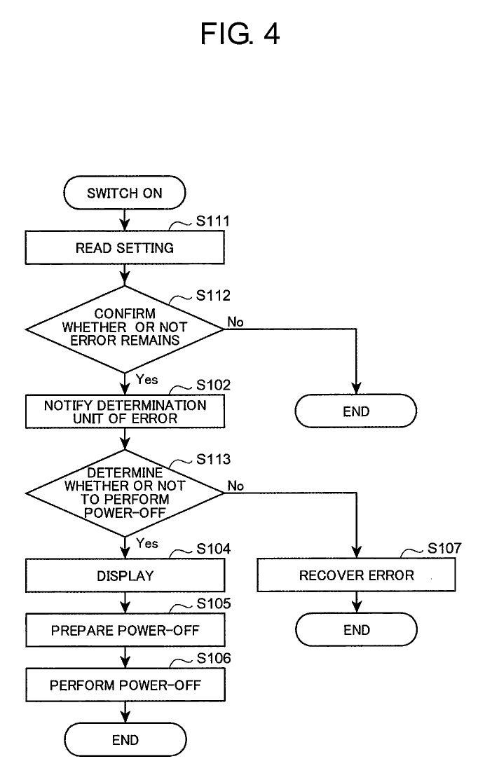

Referring to a flowchart of FIG. 4, an example procedure for activating the printer 1 being powered off based on the power-off procedure described with reference to the flowchart of FIG. 3.

When the user presses the power source switch 8, the power is supplied from the AC power source 9, and the printer 1 begins initial operation (step S111). Particularly, the control unit 2 reads the parameter 17 stored in the storage unit 4 and resets the printer 1. Herein, the parameter to be set is, for example, a number of copy sheets in a default setting, a value relating to a print setting such as presence or absence of double-sided printing in the default setting, a color adjustment parameter in the default setting, and a parameter relating to a network such as a communication protocol usable by the printer 1 or an IP address of the printer 1.

Subsequently, the error detection unit 3 confirms whether or not the error remains after the printer 1 is activated. Herein, where the error does not remain in the printer 1 (No at step S112), the printer 1 executes a normal process such as the print operation of the print data for the print job.

Where the error remains after the printer 1 is activated (Yes at step S112), on the other hand, the error detection unit 3 notifies the determination unit 13 of the error information (step S102). The processes of step S102 and following steps are substantially the same as those of steps for the power-off procedure illustrated in the flowchart of FIG. 3, and the descriptions thereof are omitted for the sake of simplicity.

According to the first embodiment described above, in a case where the error non-recoverable by the printer 1 occurs, the power-off operation is performed, thereby saving the power. In a case where the power-off operation is performed, the printer 1 is in an off state of the power. Therefore, the user can safely perform the error recovery of the printer 1. Moreover, the user using the printer 1 can recognize beforehand that the printer 1 is not activated, so that the recovery operation of the printer 1 is performed without transmission of unnecessary print data with respect the printer 1. Moreover, in a case where the error occurs, the display unit 10 of the printer 1 being powered off displays the error information of the error occurred in the printer 1 and the recovery method, so that the user can easily perform the recovery operation of the printer 1.

### Second Embodiment

Essential components of a printer 30 according to a second embodiment are substantially similar to those of the printer 1 according to the first embodiment. Components of the printer 30 that differ from those of the above embodiment will be described, and like components will be given the same reference numerals as above and description thereof will be omitted.

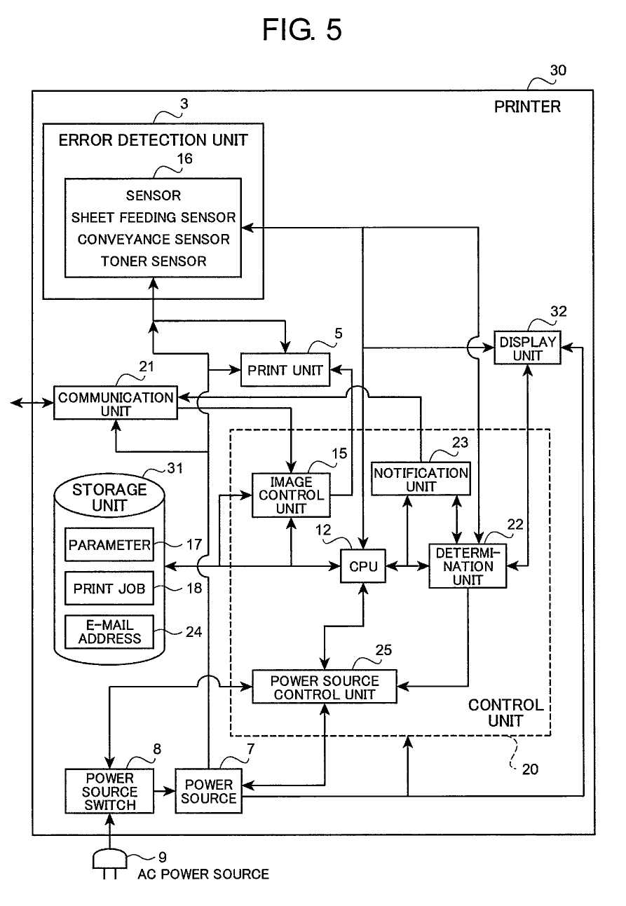

Referring to FIG. 5, the printer 30 according to the second embodiment is illustrated in a block diagram. The printer 30 includes: a control unit 20 controlling firmware installed inside the printer 30, an error detection unit 3 detecting an error occurrence; a storage unit 31 storing various information therein; a print unit 5 printing an image with respect to a sheet; a communication unit 21 communicating with an external device (not shown); a power source 7 supplying power to each component; a power source switch 8 switching supply of the power from an AC power source 9 ON and OFF; and a display unit 32 serving as an output unit displaying a state of the printer 30.

The control unit 20 includes: a central processing unit (CPU) 12 serving as a center for controlling the firmware; a determination unit 22 determining whether or not to perform power-off operation based on error information notified by the error detection unit 3; a power source control unit 25 performing the power-off operation by controlling the power source switch 8; an image control unit 15 processing by editing or mapping print data received from the external device (not shown) through the communication unit 21 and transmitting the processed print data to the print unit 5; and a notification unit 23 notifying an administrator of the power-off operation performed and the error information of the error occurred.

The communication unit 21 communicates with the external device through a network, and transmits the received print data to the image control unit 15. Moreover, the communication unit 21 serves as an interface transmitting electronic mail (hereafter referred to as e-mail) from the notification unit 23 with respect to an e-mail address 24 of the administrator. According to the first embodiment, the communication unit 21 uses the network for communication with the external device. However, the communication unit 21 may include a network communication unit transmitting the e-mail from the notification unit 23 and a communication unit serving as a host interface unit transmitting the print data received from a client computer serving as an external device through USB connection to the image control unit 15.

The determination unit 22 analyzes the error information notified by the error detection unit 3 and determines whether or not to perform power-off operation. Where the determination unit 22 determines to perform the power-off operation in a case where the notified error is not only non-recoverable by the printer 1 but also continuation of the print operation is not possible, the determination unit 22 notifies the notification unit 23, the power source control unit 25, and the display unit 32 accordingly.

In a case where the notification unit 23 receives the notification of performing the power-off operation from the determination unit 22, the notification unit 23 creates the e-mail notifying the power-off operation of the printer 1 with respect to the administrator registered beforehand. The e-mail created by the notification unit 23 is transmitted to the e-mail address 24 of the administrator through the communication unit 21. Upon completion of the e-mail transmission to the e-mail address 24 of the administrator, the notification unit 23 notifies the power source control unit 25 of notice completion through the determination unit 22.

The power source control unit 25 allows the power source 7 to be turned off and the power source switch 8 to be in an off state upon reception of the power-off notification from the determination unit 22, the display completion notification from the display unit 32 through the determination unit 22, and the notice completion notification from the notification unit 23. Herein, the off state of the power source switch 8 represents a state substantially similar to a case where the user turns off the power source switch 8. When the user turns on the power source switch 8 being in the off state, the power is applied to the printer 30.

The storage unit 31 serves as a nonvolatile storage memory and stores, for example, a parameter 17 serving as a setting value to be stored in the printer 30, a print job 18 for the print data received through the communication unit 21, and the e-mail address 24 of the administrator serving as a notifying destination of the error information in a case of the error occurrence. The storage unit 31, for example, can be a magnetic medium such as a read only memory (ROM), a flash memory, and a hard disk drive (HDD). The e-mail address 24 of the administrator is set beforehand through the display panel 32 serving as an operator panel of the printer 30.

The display unit 32, serving as the operator panel, includes a storage display device capable of displaying information thereon in a case where the power supply is stopped and a user interface receiving an input of the e-mail address 24 of the administrator. Upon reception of the notification of performing the power-off operation from the determination unit 22, the display unit 32 displays the error information and the error recovery method. Upon completion of displaying such information and method, the display unit 32 notifies the power source control unit 14 of the display completion through the determination unit 22.

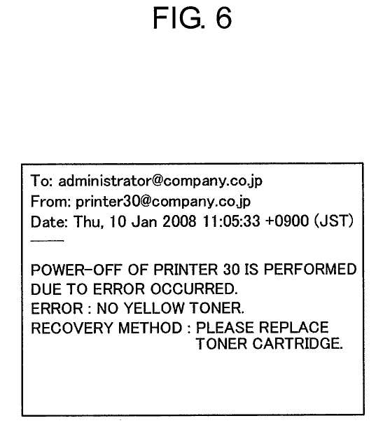

Referring to FIG. 6, an example of the e-mail created by the notification unit 23 and transmitted to the e-mail address 24 of the administrator through the communication unit 21 is illustrated. According to the second embodiment, the e-mail of the power-off notification is transmitted with respect to one administrator. However, the second embodiment of the present invention is not limited thereto. For example, a plurality of administrators may be registered, and the e-mail of the power-off notification may be transmitted to each of the registered administrators. As shown in the example e-mail of FIG. 6, the e-mail address 24 of the administrator receiving the power-off notification is “administrator@company.co.jp” and an e-mail address of a transmission origin is “printer30@company.co.jp” in a case of the error occurrence. A text of the e-mail includes, for example, a message that the power-off operation of the printer 30 is performed, the error information of the error causing to perform the power-off operation, and the error recovery method. In a case where the error detection unit 3 detects a plurality of errors occurred, information of each of the plural errors may be displayed side by side to accelerate the recovery in a single procedure, for example.

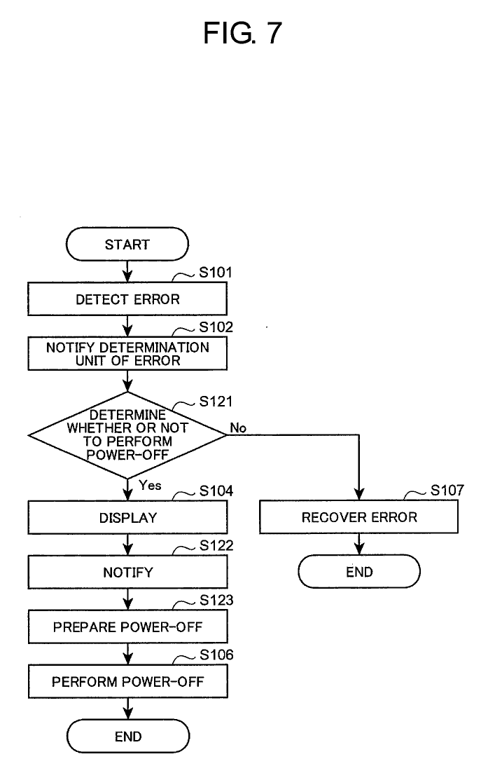

Referring to FIG. 7, an example procedure for performing the power-off operation of the printer 30 is described. Herein, only steps that differ from those in the flowchart of FIG. 3 in the above first embodiment are described.

The determination unit 22 determines whether or not to perform the power-off operation based on the error information notified by the error detection unit 3 (step S121). Where the determination unit 22 determines to perform the power-off operation in a case where the notified error is not only non-recoverable by the printer 30 but also continuation of the print operation is not possible, the determination unit 22 notifies the notification unit 23, the power source control unit 25, and the display unit 32 accordingly (Yes at step S121).

Upon reception of the power-off notification from the determination unit 22, the notification unit 23 creates the e-mail of the power-off notification with respect to the e-mail address 24 of an administrator registered beforehand. The power-off notification e-mail created by the notification unit 23 is transmitted to the e-mail address of the administrator through the communication unit 21. Subsequently, the notification unit 23 notifies the power source control unit 25 of completion of transmitting the power-off notification e-mail with a notice completion notification (step S122).

The power source control unit 25 can perform the power-off operation at a time at which the notification of performing the power-off operation from the determination unit 22, the display completion notification form the display unit 32, and the notice completion notification from the notification unit 23 are received. In a case where the print data not yet printed exists at a time of the error occurrence, the image control unit 25 allows such print data to be stored in the storage unit 31 as the print job. Moreover, in a case where the print data is being received through the communication unit 21 at a time of the error occurrence, the image control unit 15 allows such print data to be stored in the storage unit 31 as the print job (step S123).

According to the second embodiment described above, in a case where the error non-recoverable by the printer 30 occurs, the performance of power-off operation is notified with respect to the administrator, so that the administrator does not need to go to the printer 30 to confirm the power-off operation of the printer 30, thereby facilitating the maintenance of a system.

The present invention has been described above with regard to particular embodiments, but the present invention is not limited thereto. For example, in a case where the print data exists before the power-off operation is performed, the printer may allow the print data to be once stored in a nonvolatile memory device and may re-execute the print operation in a case of no error in the next activation of the printer. In a case where the error detection unit detects the error, the printer may initially attempt the recovery from the error thereby. In a case where the printer cannot be recovered from the error thereby in spite of the initial recovery attempt, the notification may be transmitted to the determination unit. Moreover, in a case where a waiting time period until the power-off operation corresponding to the error to be occurred is set beforehand, and the determination unit determines to perform the power-off operation, actual power-off operation may be performed after the waiting time period elapses.

As can be appreciated by those skilled in the art, numerous additional modifications and variation of the present invention are possible in light of the above-described teachings. It is therefore to be understood that, within the scope of the appended claims, the disclosure of this patent specification may be practiced otherwise than as specifically described herein.

What is claimed is:

1. An image forming apparatus comprising:
an error detection unit detecting an occurrence of an error in printing operation;
a determination unit determining whether or not to perform power-off operation based on a detection result of the error occurrence detected by the error detection unit;
an output unit outputting an error content of the error where the determination unit determines to perform the power-off operation; and
a power source control unit performing the power-off operation where the determination unit determines to perform the power-off operation

2. The image forming apparatus according to claim 1, wherein the output unit is a display unit.

3. The image forming apparatus according to claim 2, wherein the output unit is a storage display device capable of displaying error information even where the power supply is stopped.

4. The image forming apparatus according to claim 3, wherein the storage device uses electronic paper capable of allowing the error information displayed thereon to be rewritten by voltage supply and allowing the error information displayed thereon to continue to be displayed in a state that the voltage supply is stopped.

5. The image forming apparatus according to claim 4, wherein the electronic paper uses cholesteric liquid crystal.

6. The image forming apparatus according claim 1, wherein the output unit displays an e-mail address pre-registered.

7. The image forming apparatus according to claim 1, wherein the output unit outputs the error content and power-off information to an external unit.

8. The image forming apparatus according to claim 1, wherein the output unit outputs the error content and power-off information where the power-off operation is determined to be performed.

9. The image forming apparatus according claim 1, wherein the error detection unit includes one or more of a sheet feeding sensor, a conveyance sensor, and a toner sensor.

10. An image forming apparatus comprising:
an error detection unit detecting an occurrence of an error in printing operation;
a determination unit determining whether or not to perform power-off operation based on a detection result of the error occurrence detected by the error detection unit;
an output unit outputting power-off information where the determination unit determines to perform the power-off operation; and
a power source control unit performing the power-off operation where the determination unit determines to perform the power-off operation.

11. The image forming apparatus according to claim 10, wherein the output unit is a display unit.

12. The image forming apparatus according to claim 11, wherein the output unit is a storage display device capable of displaying error information even where the power supply is stopped.

13. The image forming apparatus according claim 10, wherein the output unit displays an e-mail address pre-registered.

14. The image forming apparatus according to claim 10, wherein the output unit outputs the error content and power-off information to an external unit.

15. The image forming apparatus according to claim 10, wherein the output unit outputs the error content and power-off information where the power-off operation is determined to be performed.

16. The image forming apparatus according claim 10, wherein the error detection unit includes one or more of a sheet feeding sensor, a conveyance sensor, and a toner sensor.
